(19) United States
(12) Patent Application Publication
(10) Pub. No.: US 2025/0199241 A1
(43) Pub. Date: Jun. 19, 2025

(54) ETCHING MASK STRUCTURE FOR FABRICATING 3D MODE CONVERTER AND METHOD OF MANUFACTURING OPTICAL WAVEGUIDE HAVING 3D MODE CONVERTER USING THE SAME

(71) Applicant: KOREA INSTITUTE OF SCIENCE AND TECHNOLOGY, Seoul (KR)

(72) Inventors: Hojoong JUNG, Seoul (KR); Sang Wook HAN, Seoul (KR); Hyeongsoon JANG, Seoul (KR); Hyungjun HEO, Seoul (KR)

(73) Assignee: KOREA INSTITUTE OF SCIENCE AND TECHNOLOGY, Seoul (KR)

(21) Appl. No.: 18/955,339

(22) Filed: Nov. 21, 2024

(30) Foreign Application Priority Data
Dec. 19, 2023 (KR) 10-2023-0186330

(51) Int. Cl. G02B 6/14

(52) U.S. Cl. CPC G02B 6/14

(57) ABSTRACT

The present invention relates to an etching mask structure for fabricating a 3D mode converter and a method of manufacturing an optical waveguide having a 3D mode converter using the same, which allows an optical waveguide having a 3D mode converter to be capable of being manufactured through a simple process. The etching mask structure may include: an etching mask in the form of a bar, positioned in a process area where optical information processing is conducted, to prevent an optical waveguide film layer stacked on the process area from being etched when an etching process is performed; and supports each formed at both ends of the etching mask to support the etching mask.

### DESCRIPTION OF GOVERNMENT-SPONSORED RESEARCH

This research was supported by the Ministry of Science and ICT [Project Identification Number: 1711175849, Subproject Number: CAP21032-000, Project Name: Support for Research Operation Expenses by the National Research Council of Science and Technology (Main Project Expenses), Project Title: Development of Integrated Quantum Interconnect Technology for Long-Distance Quantum Networks].

This research was supported by the Ministry of Science and ICT [Project Identification Number: 1711193304, Subproject Number: 2020-0-00890-004, Project Name: Advancement of Quantum Cryptography Communication Integration and Transmission Technology, Project Title: Development of Trusted Node Core and Interface for Ensuring Interoperability between QKD Protocols].

This research was supported by the Ministry of Science and ICT [Project Identification Number: 1711193343, Subproject Number: 2020-0-00947-004, Project Name: Advancement of Integrated and Transmission Technology for Quantum Cryptography Communication, Project Title: Development of Photonic Integrated Circuits for Quantum Communication Based on Entangled Photon Pairs].

### CROSS REFERENCE TO RELATED APPLICATION

The present application claims priority to Korean Patent Application No. 10-2023-0186330, filed on Dec. 19, 2023, the entire contents of which is incorporated herein for all purposes by this reference.

### BACKGROUND OF THE INVENTION

### Field of the Invention

The present invention relates to an etching mask structure for fabricating a 3D mode converter and a method of manufacturing an optical waveguide having a 3D mode converter using the same, more specifically, to an etching mask structure for fabricating a 3D mode converter and a method of manufacturing an optical waveguide having a 3D mode converter using the same, which allows an optical waveguide having a 3D mode converter to be capable of being manufactured through a simple process.

### Description of the Related Art

In order to increase the optical coupling efficiency between an optical fiber and a photonics chip, enabling the input and output of light without loss, a mode size of an optical waveguide provided in a photonics chip needs to be implemented to be similar to the mode size of an optical fiber.

As described above, there are two methods for implementing the mode size of the optical waveguide to be similar to the mode size of the optical fiber: one is a method of reducing the mode size of the optical fiber, and the other is a method of increasing the mode size of the optical waveguide.

There are methods of reducing the mode size of the optical fiber, such as a lensed fiber, where an end of the optical fiber is shaped into a lens, and a tapered fiber, where an end of the optical fiber is made into a tapered shape. However, these methods have issues such as alignment problems between the optical fiber and the optical waveguide, as well as the significant amount of time required for assembly.

There are methods of increasing the mode size of the optical waveguide, such as using a thin optical waveguide to weaken light confinement. However, this method requires a large bending radius, which has issues of having a limitation of integration and causes difficulties in using nonlinear phenomena.

In order to solve these issues, research on a mode conversion technology, which fabricates a mode converter on a silicon substrate, is being conducted from various angles. In the mode converter, a process area where optical circuits are concentrated strongly confines light with a small mode size by increasing the width or height of an optical waveguide, while an interface area with input/output terminals weakly confines light with a large mode size by reducing the width or height of the optical waveguide.

However, there is a limitation in increasing the mode size by increasing the width or height of the optical waveguide, and there is an issue of process complexity due to additional lithography and etching processes.

### DOCUMENTS OF RELATED ART

(Patent Document 1) Korean Patent Publication No. 10-0886069 (published on Feb. 26, 2009)

### SUMMARY OF THE INVENTION

The present invention has been has been made in an effort to solve the conventional problems as described above, and an object of the present invention is to provide an etching mask structure for fabricating a 3D mode converter, which allows an optical waveguide having a 3D mode converter to be capable of being manufactured through a simple process.

Another object of the present invention is to provide a method of manufacturing an optical waveguide having a 3D mode converter using an etching mask structure, which enables the manufacturing of an optical waveguide having a 3D mode converter through a simple process that etches only input and output interface areas using a separate etching mask structure.

There is provided an etching mask structure for fabricating a 3D mode converter, according to the present invention, in order to achieve the aforementioned objects. The etching mask structure may include: an etching mask in the form of a bar, positioned in a process area where optical information processing is conducted, to prevent an optical waveguide film layer stacked on the process area from being etched when an etching process is performed; and supports each formed at both ends of the etching mask to support the etching mask.

In addition, in the etching mask structure for fabricating a 3D mode converter according to the present invention, the etching mask may have a width formed so that a semiconductor substrate, on which an optical waveguide film layer is stacked, is positioned between supports each formed at both ends of the etching mask, and a height formed to cover the entire process area.

In addition, in the etching mask structure for fabricating a 3D mode converter according to the present invention, the supports may have a height formed so that a predetermined space is formed between a lower portion of the etching mask supported by the supports and an upper portion of a semiconductor substrate on which the optical waveguide film layer is stacked.

In addition, in the etching mask structure for fabricating a 3D mode converter according to the present invention, the etching mask may be implemented in a grid form.

In addition, in the etching mask structure for fabricating a 3D mode converter according to the present invention, the etching mask structure for fabricating a 3D mode converter may be implemented with the same material as a material forming the semiconductor substrate.

In addition, there is a method of manufacturing an optical waveguide having a 3D mode converter using an etching mask structure, according to the present invention, in order to achieve the aforementioned objects. The method may include: preparing a semiconductor substrate on which an optical waveguide film layer is stacked; positioning the etching mask structure according to any one of claims 1 to 5 in a process area where optical information processing is conducted, and then performing an etching process to locally etch the optical waveguide film layer in input and output interface areas; performing a lithography process to form an optical waveguide pattern on the semiconductor substrate where the optical waveguide film layer in the input and output interface areas has been locally etched; performing an etching process to remove all the optical waveguide film layer except for a portion where the optical waveguide pattern is formed.

In addition, in the method of manufacturing an optical waveguide having a 3D mode converter using an etching mask structure, according to the present invention, in the locally etching of the optical waveguide film layer, heights of the process area and the input and output interface areas may be adjusted according to an etching time.

In addition, in the method of manufacturing an optical waveguide having a 3D mode converter using an etching mask structure, according to the present invention, in the locally etching of the optical waveguide film layer, plasma may be scattered from an upper edge of the etching mask structure, and a mode converter area, which is a portion where a height of the optical waveguide film layer changes, may be formed in a tapered form.

In addition, in the method of manufacturing an optical waveguide having a 3D mode converter using an etching mask structure, according to the present invention, a tilt angle of the mode converter area may be determined according to a gap between an upper portion of the etching mask structure and an upper portion of the semiconductor substrate on which the optical waveguide film layer is stacked.

In addition, in the method of manufacturing an optical waveguide having a 3D mode converter using an etching mask structure, according to the present invention, the mode converter area may be formed to be at least 10 μm or more.

In addition, in the method of manufacturing an optical waveguide having a 3D mode converter using an etching mask structure, according to the present invention, in the forming of the optical waveguide pattern, widths of the process area and the input and output interface areas may be adjusted according to a width of the optical waveguide pattern formed on the semiconductor substrate, where the optical waveguide film layer in the input and output interface areas has been locally etched, through a lithography process.

Other specific details of the embodiments are included in the “detailed description of the invention” and the “drawings” attached hereto.

Advantages and features of the present invention and methods of achieving the advantages and features will be clear with reference to various embodiments described in detail below together with the accompanying drawings.

However, it should be understood that the present invention are not limited to the configuration of each of the embodiments disclosed below, but may also be implemented in a variety of other forms, and that each of the embodiments disclosed herein is provided only to make the disclosure of the present invention complete and to fully inform those skilled in the art to which the present invention belong of the scope of the present invention, and that the present invention are only defined by the scope of each claim of the appended claims.

According to the present invention, it is possible to manufacture an optical waveguide having a 3D mode converter through a simple process that etches only the input and output interface areas using a separate etching mask structure.

### BRIEF DESCRIPTION OF THE DRAWINGS

FIG. 1 is a view exemplarily illustrating an optical waveguide having a 3D mode converter formed on a photonics chip, according to the present invention.

FIG. 2 is a perspective view of an etching mask structure for fabricating a 3D mode converter according to an embodiment of the present invention.

FIG. 3 is a top plan view of an etching mask structure for fabricating a 3D mode converter according to an embodiment of the present invention.

FIG. 4 is a front view of an etching mask structure for fabricating a 3D mode converter according to an embodiment of the present invention.

FIG. 5 is a side view of an etching mask structure for fabricating a 3D mode converter according to an embodiment of the present invention.

FIG. 6 is a top plan view of an etching mask structure for fabricating a 3D mode converter according to another embodiment of the present invention.

FIG. 7 is a view illustrating a method of manufacturing an optical waveguide having a 3D mode converter using an etching mask structure according to an embodiment of the present invention.

FIG. 8 is a view illustrating a process of locally etching an optical waveguide film layer in the input and output interface areas according to the present invention.

FIGS. 9 and 10 are views exemplarily illustrating optical microscope images of a mode converter area of an optical waveguide fabricated according to the present invention.

FIG. 11 is a conceptual view illustrating an optical waveguide pattern to be formed on a semiconductor substrate on which a local etching process has been performed, according to the present invention, as well as a structure performing the function of a 3D mode converter included in an actual optical waveguide.

FIGS. 12 and 13 are views exemplarily illustrating photographs taken by SEM of cross-sections of a process area and an interface area of an optical waveguide fabricated according to the present invention.

FIGS. 14 and 15 are views exemplarily illustrating simulated results of the optical coupling efficiency of an optical waveguide and a lensed fiber fabricated according to the present invention.

FIGS. 16 and 17 are views exemplarily illustrating measured results of the optical coupling efficiency of an optical waveguide and a lensed fiber actually fabricated according to the present invention.

### DETAILED DESCRIPTION OF THE INVENTION

It should be understood that before describing the present invention in detail, the terms and words used in the present specification are not to be interpreted unconditionally and without limitation in the general or dictionary meaning, and that the inventor of the present invention may appropriately define and use the concepts of various terms to best describe his/her own invention, and further that these terms and words are to be interpreted in a meaning and concept consistent with the technical spirit of the present invention.

That is, it should be understood that the terms used in the present specification are used only to describe preferred embodiments of the present invention and are not intended to specifically limit the content of the present invention, and that these terms are terms defined in consideration of the various possibilities of the present invention.

In addition, in the present specification, it should be understood that singular expressions may include plural expressions unless the context clearly indicates a different meaning, and similarly, the plural expressions may have a singular meaning.

Throughout the present specification, where a constituent element is described as “comprising/including” another element, which, unless specifically stated to the contrary, may mean to include any other constituent element and not to exclude any other constituent element.

Further, when a constituent element is described as “existing within, or being installed in connection with,” another constituent element, it should be understood that the constituent element may be directly connected to, installed in contact with, or installed spaced a certain distance apart from another constituent element, and that in case of being installed spaced a certain distance apart, there may be a third constituent element or means for fixing or connecting the constituent element to another constituent element, and the description of the third constituent element or means may be omitted.

In contrast, when a constituent element is described as being “directly connected” or “directly accessed” to another constituent element, it should be understood that there is no third constituent element or means.

Similarly, other expressions that describe the relationship between respective constituent elements, such as “between” and “directly between”, or “adjacent to” and “directly adjacent to”, should be interpreted in the same manner.

In addition, it should be understood that when the terms “one surface,” “the other surface,” “one side,” “the other side,” “first,” “second,” and the like, are used in the present specification, they are used to refer to one constituent element so that this one constituent element can be clearly distinguished from other constituent elements, and that the meaning of the corresponding constituent element is not limited by such terms.

In addition, when the terms relating to a position, such as “top,” “bottom,” “left,” “right,” and the like, are used in the present specification, it should be understood that they refer to a relative position in the corresponding drawing with respect to the corresponding constituent element, and should not be understood that the terms relating to a position refer to an absolute position, unless the absolute position is specified with respect to the constituent element.

Further, it should be understood that in the specification of the present invention, the terms “unit,” “device,” “module,” “apparatus,” and the like, when used, mean a unit capable of performing one or more functions or operations, which may be implemented in hardware or software, or a combination of hardware and software.

In addition, in specifying the reference numeral for each constituent element in each drawing, the present specification is intended to indicate that the same constituent element has the same reference numeral even though it is illustrated in different drawings, i.e., the same reference numeral throughout the specification refers to the same constituent element.

In the drawings accompanying the present specification, the size, position, coupling relationships, etc. of each of the constituent elements constituting the present invention may be exaggerated, reduced, or omitted in some respects in order to convey the spirit of the present invention with sufficient clarity or for convenience of description, and thus the proportions or scales may not be strictly accurate.

In addition, in describing the present invention below, detailed descriptions of the configuration, for example, of known art, including prior art, may be omitted where it is determined that such descriptions would unnecessarily obscure the subject matter of the present invention.

Hereinafter, with reference to the accompanying drawings, an etching mask structure for fabricating a 3D mode converter and a method of manufacturing an optical waveguide having a 3D mode converter using the same, according to a preferred embodiment of the present invention, will be described in detail.

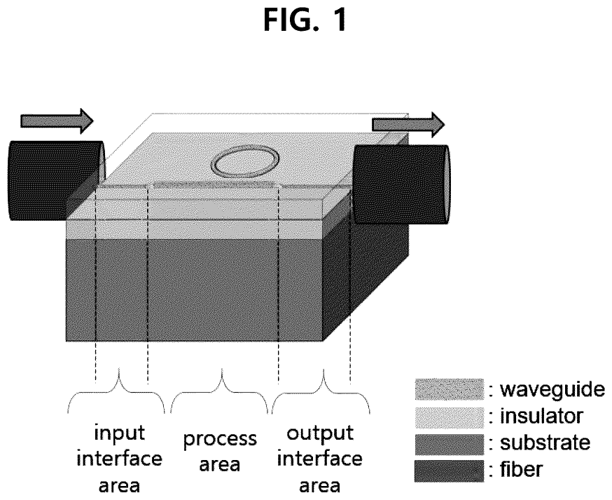

FIG. 1 is a view exemplarily illustrating an optical waveguide having a 3D mode converter formed on a photonics chip, according to the present invention. An optical waveguide 130 having a 3D mode converter formed on a photonics chip may be divided into an input interface area that receives light from an input optical fiber, a process area that performs information processing on light received through the input interface area, and an output interface area that outputs light information-processed in the process area to an output optical fiber.

As illustrated in FIG. 1, the optical waveguide 130 having a 3D mode converter formed according to the present invention is formed with a lower height in the input interface area and output interface area to enhance optical coupling efficiency with the input and output optical fibers, and is formed with a greater height in the process area to be suitable for optical information processing.

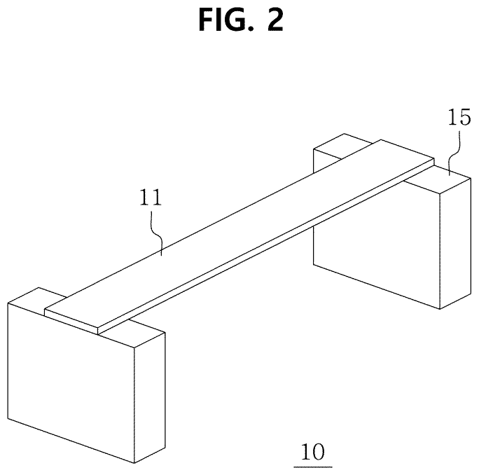

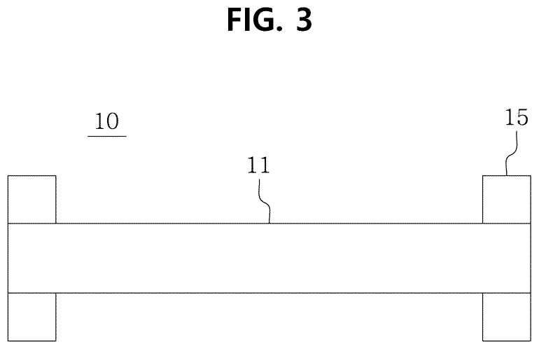

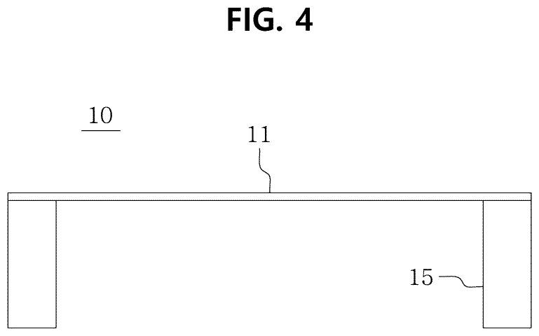

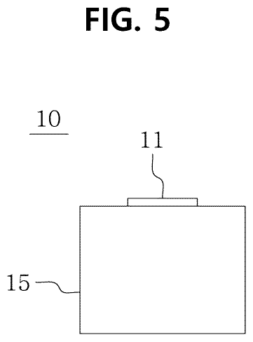

FIG. 2 is a perspective view of an etching mask structure for fabricating a 3D mode converter according to an embodiment of the present invention, FIG. 3 is a top plan view of an etching mask structure for fabricating a 3D mode converter according to an embodiment of the present invention, FIG. 4 is a front view of an etching mask structure for fabricating a 3D mode converter according to an embodiment of the present invention, and FIG. 5 is a side view of an etching mask structure for fabricating a 3D mode converter according to an embodiment of the present invention.

As illustrated in FIGS. 2 to 5, an etching mask structure 10 for fabricating a 3D mode converter according to an embodiment of the present invention may be configured to include an etching mask 11 and supports 15.

The etching mask 11 is implemented in the form of a bar and is positioned in the process area where optical information processing is conducted, preventing the optical waveguide film layer stacked in the process area from being etched when the etching process is performed.

The supports 15 are formed at both ends of the etching mask 11, respectively, and may support the etching mask 11.

The aforementioned etching mask 11 and supports 15 may be integrally formed.

The aforementioned etching mask 11 is formed with a width W such that a semiconductor substrate, on which an optical waveguide film layer is stacked, may be positioned between the supports 15 formed at both ends of the etching mask 11, and is formed with a height H to cover the entire process area.

The supports 15 may be formed with the height H so that a predetermined space is formed between a lower portion of the etching mask 11 and an upper portion of the semiconductor substrate on which the optical waveguide film layer is stacked.

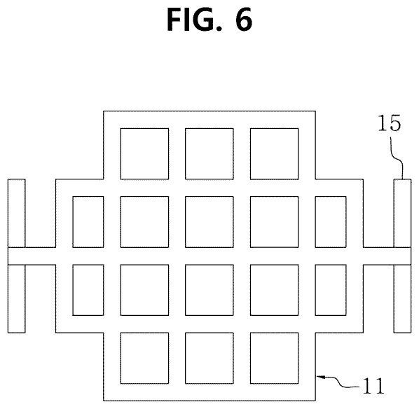

FIG. 6 is a top plan view of an etching mask structure for fabricating a 3D mode converter according to another embodiment of the present invention. The etching mask structure 10 for fabricating a 3D mode converter, according to another embodiment of the present invention, may have the etching mask 11 implemented in a grid form.

As described above, when the etching mask 11 is implemented in a grid form, mass production of photonics chips may be enabled.

The etching mask structure 10 for fabricating a 3D mode converter according to the present invention, as described above, may be implemented with the same material as a material forming the semiconductor substrate, for example, silicon (Si), but is not limited thereto.

The reason for implementing the etching mask structure 10 according to the present invention with the same material as that forming the semiconductor substrate is to minimize the occurrence of contamination during the process.

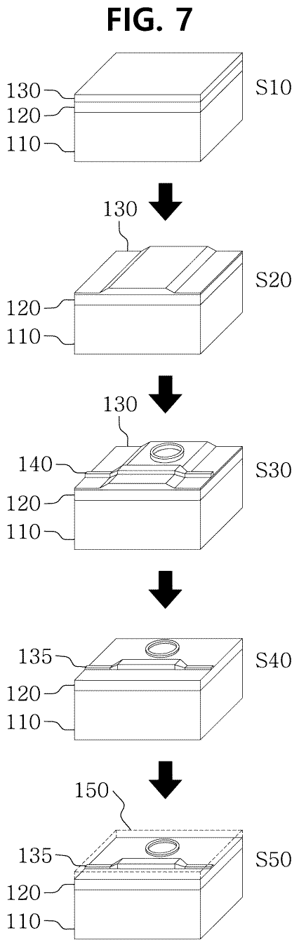

FIG. 7 is a view illustrating a method of manufacturing an optical waveguide having a 3D mode converter using an etching mask structure according to an embodiment of the present invention.

First, a semiconductor substrate 110 on which the optical waveguide film layer 130 is stacked is prepared (S10).

The semiconductor substrate 110 is a substrate for supporting various constituent elements of a photonics chip, including the optical waveguide, and may be made of a silicon substrate, but is not limited thereto.

The optical waveguide film layer 130 stacked on the semiconductor substrate 110 may be implemented as lithium niobate (LiNbO₃), aluminum nitride (AlN), or the like, but is not limited thereto.

A dielectric layer 120 may be formed between the semiconductor substrate 110 and the optical waveguide film layer 130.

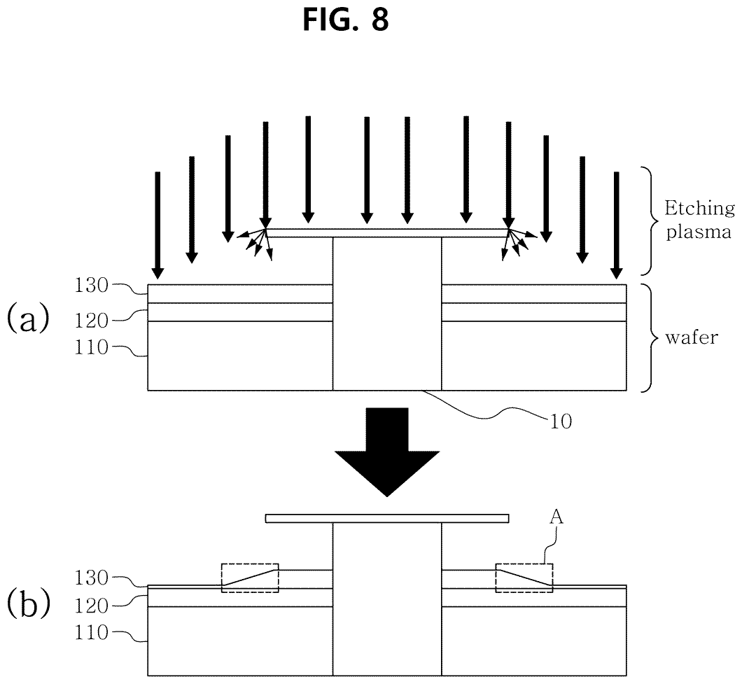

Subsequently, as illustrated in (a) of FIG. 8, after positioning the etching mask structure 10 according to the present invention in the process area where optical information processing is conducted, an etching process may be performed to locally etch the optical waveguide film layer 130 in the input and output interface areas (S20).

After positioning the etching mask structure 10 according to the present invention in the process area in step S20 and performing the etching process, the etching mask structure 10 protects the process area from anisotropic plasma.

Accordingly, the process area is not etched due to the etching mask structure 10, and only the input and output interface areas may be etched.

The etching process in step S20 may be performed using inductive coupled plasma-reactive ion etching (ICP-RIE) equipment, but is not limited thereto.

When performing the etching process in step S20 described above, as illustrated in (a) of FIG. 8, plasma may be scattered from an upper edge of the etching mask structure 10.

Due to this plasma scattering, as illustrated in (b) of FIG. 8, a portion of the optical waveguide film layer 130 where a height changes due to the etching process, i.e., a mode converter area A in which the process area and the input and output interface areas are connected, may be formed in a tapered form.

Here, a tilt angle of the mode converter area A may be determined according to a gap between an upper portion of the etching mask structure 10 and an upper portion of the semiconductor substrate 110 on which the optical waveguide film layer 130 is stacked. When the gap between the upper portion of the etching mask structure 10 and the upper portion of the semiconductor substrate 110 on which the optical waveguide film layer 130 is stacked is wide, the tilt angle becomes gradual, and when the gap between the upper portion of the etching mask structure 10 and the upper portion of the semiconductor substrate 110 on which the optical waveguide film layer 130 is stacked is narrow, the tilt angle becomes steep.

When the etching process is performed through step S20 described above, the process area is not etched due to the etching mask structure 10, only the input and output interface areas are etched, and the mode converter area, which is a portion where the process area and the input and output interface areas are connected, may be formed in a tapered form.

As described above, in an embodiment of the present invention, the etching process of step S20 described above makes it possible to adjust the heights of the input and output interface areas and the process area of the optical waveguide, and the heights of the process area and the input and output interface areas of the optical waveguide may be adjusted according to an etching time. That is, as the etching time increases, the heights of the input and output interface areas become lower.

Subsequently, a lithography process may be performed to form an optical waveguide pattern 140 on the semiconductor substrate 110, where the etching process was performed in step S20 described above, i.e., on the semiconductor substrate 110 where the optical waveguide film layer 130 in the input and output interface areas has been locally etched (S30).

In the lithography process of step S30 described above, a narrow width of the optical waveguide pattern 140 may be formed in the input and output interface areas, and a wide width of the optical waveguide pattern 140 may be formed in the process area. In this case, when forming the width of the optical waveguide pattern 140 wider in the process area, the width of the optical waveguide pattern 140 in the mode converter area A formed in the etching process of step S20 described above may be formed so that the width of the optical waveguide pattern 140 gradually widens.

As described above, in the embodiment of the present invention, the widths of the input and output interface areas and the process area of the optical waveguide may be adjusted through the lithography process of step S30 described above.

That is, by adjusting the width of the optical waveguide pattern 140 formed on the semiconductor substrate 110, where the optical waveguide film layer 130 in the input and output interface areas has been locally etched, the widths of the process area and the input and output interface areas of the optical waveguide may be adjusted.

Subsequently, an etching process may be performed to etch and remove all of the optical waveguide film layer 130 except for the portion where the optical waveguide pattern 140 was formed in step S30 described above (S40).

When the etching process is performed in step S40 described above, only an optical waveguide 135 corresponding to the optical waveguide pattern 140 remains on the semiconductor substrate 110.

Subsequently, a deposition process may be performed to form a dielectric layer 150 on the semiconductor substrate 110 where the 3D optical waveguide 135 has been formed (S50).

Through the series of processes described above, the optical waveguide 135 formed on the semiconductor substrate 110 has a lower height in the input and output interface areas, and a greater height in the process area compared to the input and output interface areas.

In the embodiment of the present invention, the height of the optical waveguide 135 formed on the semiconductor substrate 110 is formed differently in the input and output interface areas and the process area. However, the width of the optical waveguide 135 may also be formed differently, which may be achieved through the lithography process.

That is, by forming the width of the optical waveguide pattern 140 narrower in the input and output interface areas and wider in the process area in the lithography process of step S30 described above, the width of the optical waveguide 135 may be formed differently.

As described above, the embodiment of the present invention has been described with an example of forming a 3D mode converter in an optical waveguide with a ridge-type structure. However, the method of manufacturing an optical waveguide having a 3D mode converter using an etching mask structure according to the present invention may be applied to optical waveguides with various structures, such as rib-type, slot-type, slab-type, or arrow-type structures.

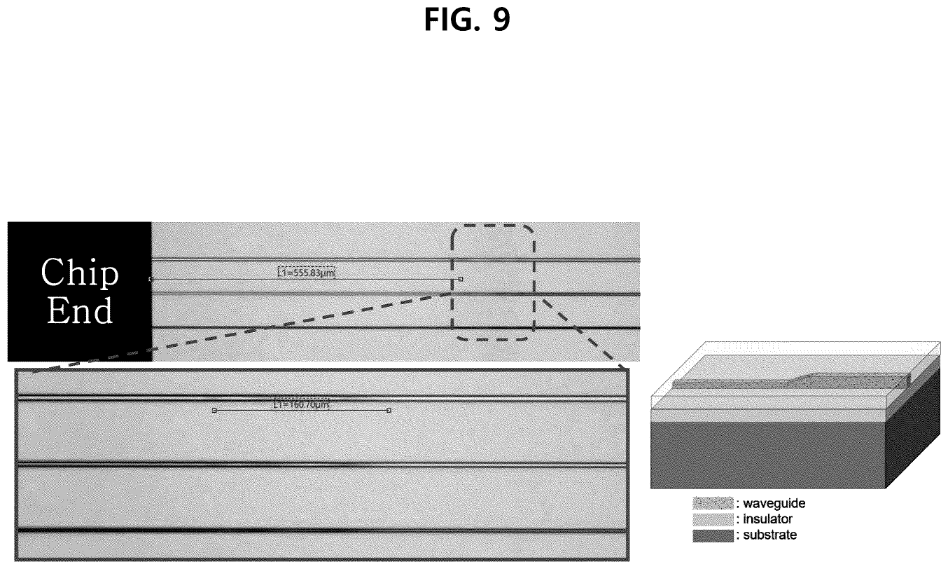

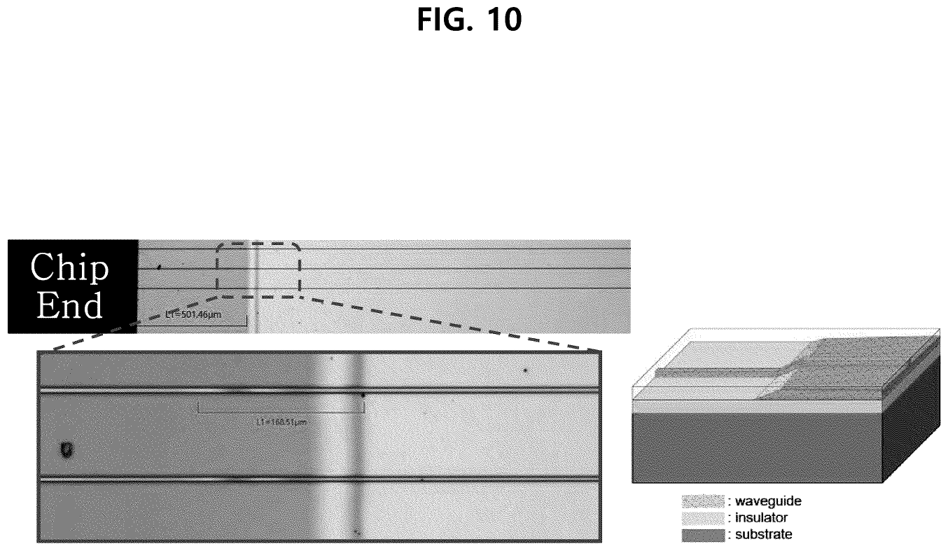

FIGS. 9 and 10 are views exemplarily illustrating optical microscope images of a mode converter area of an optical waveguide fabricated according to the present invention.

FIG. 9 is a view exemplarily illustrating an optical microscope image of a mode converter area of an optical waveguide with a ridge-type structure, implemented with an aluminum nitride (AlN) material, fabricated according to the present invention. It can be seen that a rainbow-colored gradient (approximately 160 μm) is made in the mode converter area through the optical microscope image of the mode converter area, which indicates that a smooth slope has been formed in the mode converter area.

FIG. 10 is a view exemplarily illustrating an optical microscope image of a mode converter area of an optical waveguide with a rib-type structure, implemented with a lithium niobate (LiNbO₃) material, fabricated according to the present invention. It can be seen that a rainbow-colored gradient (approximately 170 μm) is made in the mode converter area through the optical microscope image of the mode converter area, which indicates that a smooth slope has been formed in the mode converter area.

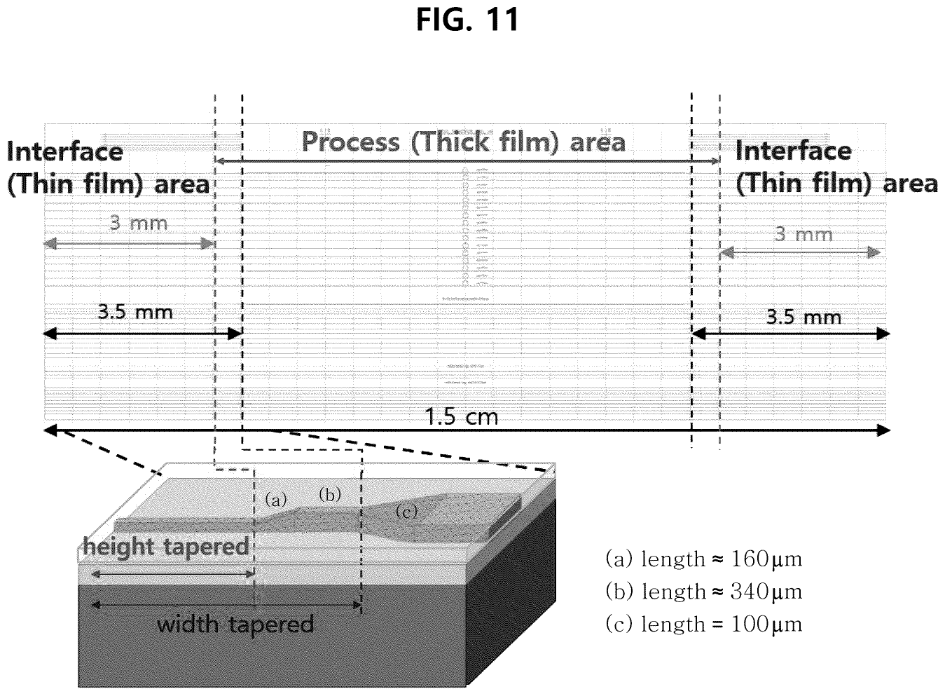

FIG. 11 is a conceptual view illustrating an optical waveguide pattern to be formed on a semiconductor substrate on which a local etching process was performed according to the present invention, and a structure performing the function of a 3D mode converter provided in an actual optical waveguide. The mode converter area provided in the optical waveguide may include a section (a) for converting the height of the optical waveguide and a section (c) for converting the width of the optical waveguide, with a buffer section (b) included between the section (a) for converting the height of the optical waveguide and the section (c) for converting the width thereof.

When the mode converter area provided in the optical waveguide changes abruptly, for example, by 1 to 10 nm, excess losses may occur.

Therefore, to minimize losses during mode conversion of the optical waveguide, that is, during the width and height conversion of the optical waveguide, it is desirable to form each conversion section, i.e., the height conversion section (a), buffer section (b), and width conversion section (c)—to be at least 10 μm or more.

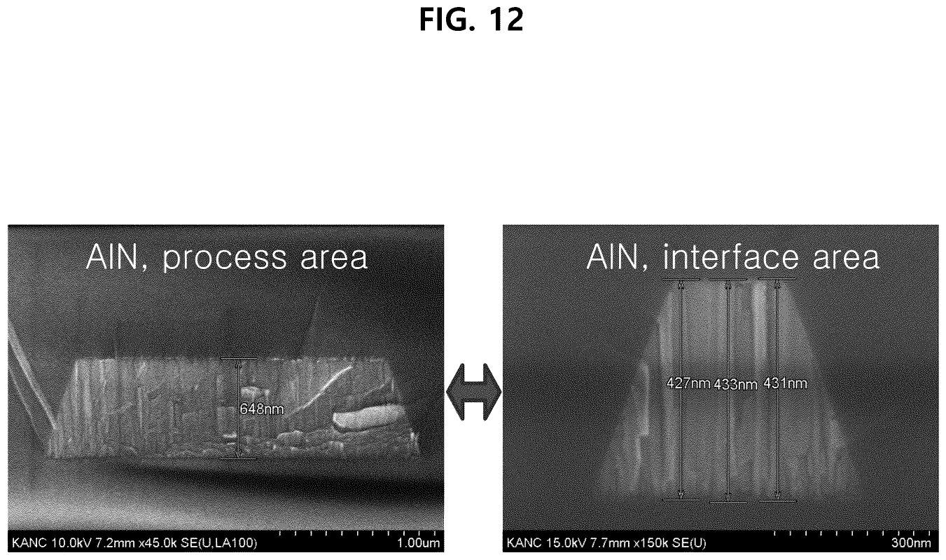

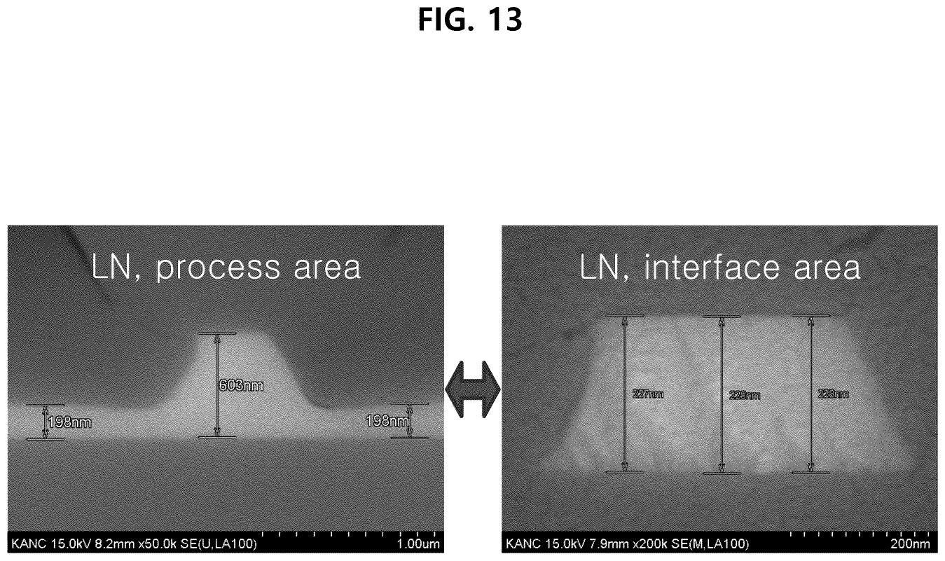

FIGS. 12 and 13 are views exemplarily illustrating photographs taken by SEM of cross-sections of a process area and an interface area of an optical waveguide fabricated according to the present invention. FIG. 12 is a view exemplarily illustrating photographs taken by SEM of cross-sections of the process area and interface areas of a ridge-type optical waveguide structure implemented with an aluminum nitride (AlN) material, fabricated according to the present invention. It can be seen that the height in the process area is approximately 650 nm, while the height in the interface area is approximately 430 nm, confirming a height difference between the process area and the interface areas.

FIG. 13 is a view exemplarily illustrating photographs taken by SEM of cross-sections of the process area and interface areas of a rib-type optical waveguide structure implemented with a lithium niobate (LiNbO₃) material, fabricated according to the present invention. It can be seen that the height in the process area is approximately 600 nm, while the height in the interface area is approximately 228 nm, confirming a height difference between the process area and the interface areas.

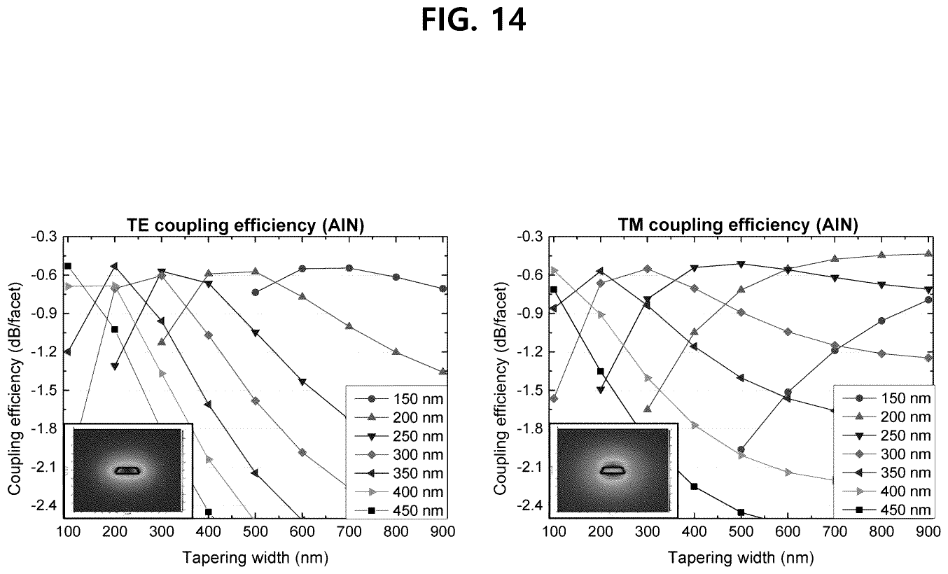

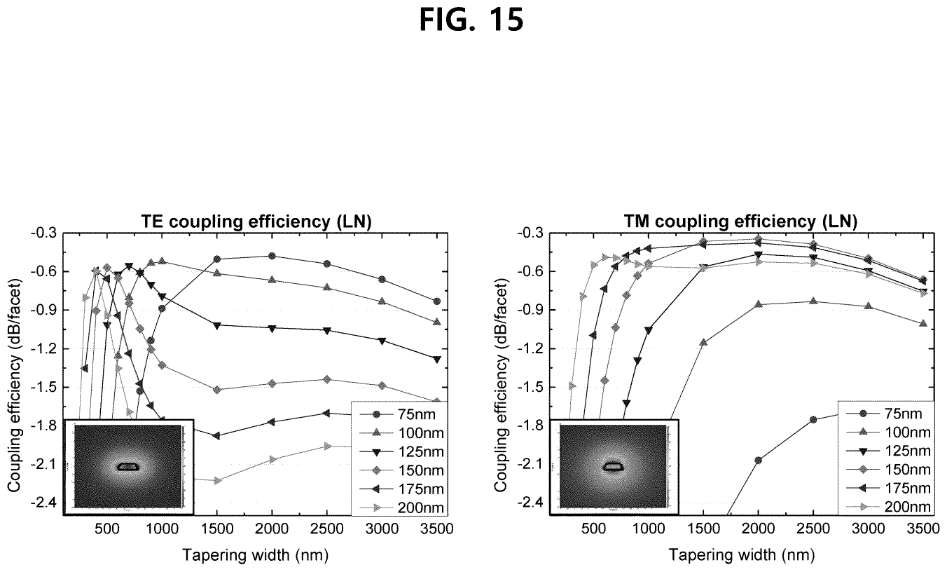

FIGS. 14 and 15 are views exemplarily illustrating simulated results of the optical coupling efficiency of an optical waveguide and a lensed fiber fabricated according to the present invention. FIG. 14 is a view exemplarily illustrating the simulation results using a ridge-type optical waveguide structure implemented with an aluminum nitride (AlN) material fabricated according to the present invention, and FIG. 15 is a view exemplarily illustrating the simulation results using a rib-type optical waveguide structure implemented with a lithium niobate (LiNbO₃) material fabricated according to the present invention.

Through the simulation results of FIGS. 14 and 15, it can be seen that optimizing the optical efficiency may be achieved by converting the width and height of the optical waveguide.

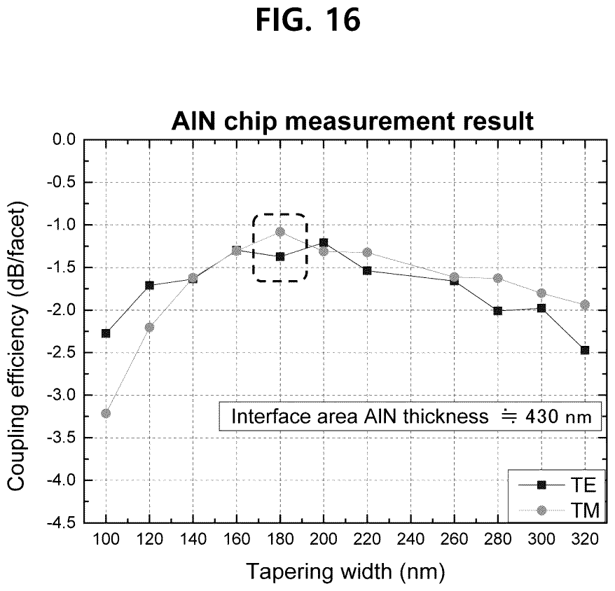

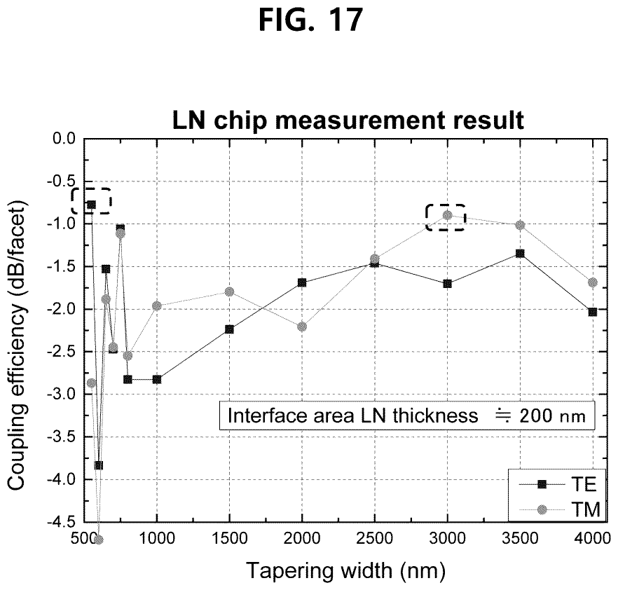

FIGS. 16 and 17 are views exemplarily illustrating measured results of the optical coupling efficiency of an optical waveguide and a lensed fiber actually fabricated according to the present invention.

FIG. 16 is a view exemplarily illustrating the measured results using an optical waveguide implemented with an aluminum nitride (AlN) material actually fabricated according to the present invention. It can be seen that when a transverse magnetic (TM) mode input is applied, the optical waveguide with dimensions of 180 nm×420 nm has optical efficiency of a minimum value (for example, −1.08 dB/facet).

FIG. 17 is a view exemplarily illustrating the measured results using an optical waveguide implemented with a lithium niobate (LiNbO₃) material actually fabricated according to the present invention. It can be seen that when a transverse electric (TE) mode input is applied, the optical waveguide with dimensions of 550 nm×200 nm has optical efficiency of a minimum value (for example, 0.77 dB/facet).

As described above, the optical waveguide fabricated according to the present invention exhibits differences in width and height in the input and output interface areas and the process area, resulting in mode conversion. That is, in the process area, where the width and height of the optical waveguide are formed greater than in the interface areas, light is strongly confined with a small mode size. In contrast, in the interface areas, where the width and height of the optical waveguide are formed smaller than in the process area, light is weakly confined with a large mode size.

The optical waveguide fabricated according to the present invention is expected to exhibit good optical coupling efficiency not only with lensed fibers but also with ultra high numerical aperture (UHNA) fibers, single-mode fibers (SMF), and the like, provided that the bottom cladding and top cladding are sufficient.

In addition, after standardizing the chip size with high precision through plasma dicing, using optical adhesive agents (for example, optical adhesive) used in photonics packaging is expected to significantly contribute to photonics chip packaging with low optical coupling losses.

While the description above describes various preferred embodiments of the present invention with some examples, it should be understood that the description of the various embodiments described in this “detailed description of the invention” section is merely illustrative, and those skilled in the art to which the present invention belong can modify the present invention from the above description to perform various other embodiments, or to perform embodiments equivalent to the present invention.

In addition, it should be understood that the present invention are not limited by the description above, as the present invention may be implemented in a variety of other forms, and that the above description is provided only to make the disclosure of the present invention complete and to inform those skilled in the art to which the present invention belong of the scope of the present invention, and that the present invention are only defined by the respective claims of the claims.

### DESCRIPTION OF REFERENCE NUMERALS

10. Etching mask structure,
11. Etching mask,
15. Support,
110. Semiconductor substrate,
120 and 150. Dielectric layer,
130. Optical waveguide film layer,
135. Optical waveguide,
140. Optical waveguide pattern

What is claimed is:

1. An etching mask structure for fabricating a 3D mode converter, comprising:
an etching mask in the form of a bar, positioned in a process area where optical information processing is conducted, to prevent an optical waveguide film layer stacked on the process area from being etched when an etching process is performed; and
supports each formed at both ends of the etching mask to support the etching mask.

2. The etching mask structure of claim 1, wherein the etching mask has a width formed so that a semiconductor substrate, on which an optical waveguide film layer is stacked, is positioned between supports each formed at both ends of the etching mask, and a height formed to cover the entire process area.

3. The etching mask structure of claim 1, wherein the supports have a height formed so that a predetermined space is formed between a lower portion of the etching mask supported by the supports and an upper portion of a semiconductor substrate on which the optical waveguide film layer is stacked.

4. The etching mask structure of claim 1, wherein the etching mask is implemented in a grid form.

5. The etching mask structure of claim 1, wherein the etching mask structure for fabricating a 3D mode converter is implemented with the same material as a material forming the semiconductor substrate.

6. A method of manufacturing an optical waveguide having a 3D mode converter using an etching mask structure, the method comprising:
preparing a semiconductor substrate on which an optical waveguide film layer is stacked;
positioning the etching mask structure according to claim 1 in a process area where optical information processing is conducted, and then performing an etching process to locally etch the optical waveguide film layer in input and output interface areas;
performing a lithography process to form an optical waveguide pattern on the semiconductor substrate where the optical waveguide film layer in the input and output interface areas has been locally etched; and
performing an etching process to remove all the optical waveguide film layer except for a portion where the optical waveguide pattern is formed.

7. The method of claim 6, wherein in the locally etching of the optical waveguide film layer, heights of the process area and the input and output interface areas are adjusted according to an etching time.

8. The method of claim 6, wherein in the locally etching of the optical waveguide film layer, plasma is scattered from an upper edge of the etching mask structure, and a mode converter area, which is a portion where a height of the optical waveguide film layer changes, is formed in a tapered form.

9. The method of claim 8, wherein a tilt angle of the mode converter area is determined according to a gap between an upper portion of the etching mask structure and an upper portion of the semiconductor substrate on which the optical waveguide film layer is stacked.

10. The method of claim 8, wherein the mode converter area is formed to be at least 10 μm or more.

11. The method of claim 6, wherein in the forming of the optical waveguide pattern, widths of the process area and the input and output interface areas are adjusted according to a width of the optical waveguide pattern formed on the semiconductor substrate, where the optical waveguide film layer in the input and output interface areas has been locally etched, through a lithography process.
